(19) United States
(12) Patent Application Publication
(10) Pub. No.: US 2012/0050982 A1
(43) Pub. Date: Mar. 1, 2012

(54) OPTICAL DISK DRIVE WITH DUST-PROOF FUNCTION

(76) Inventors: Li-Sheng Lin, New Taipei City (TW); Jia-Hung Lee, New Taipei City (TW); Shun-De Bai, New Taipei City (TW); Cheng-Hsiang Chuang, New Taipei City (TW)

(21) Appl. No.: 13/206,538

(22) Filed: Aug. 10, 2011

(30) Foreign Application Priority Data
Aug. 31, 2010 (TW) 099216866

(51) Int. Cl. G06F 1/16

(52) U.S. Cl. 361/679.33

(57) ABSTRACT

An optical disk drive includes a main body having a tray and a casing for covering the tray, and a bezel connected to a side of the casing of the main body for shielding an opening of a housing when the main body is received inside the housing. The optical disk drive further includes a dust-proof structure combined with the bezel for covering a gap between the bezel and the casing of the main body so as to provide a dust-proof function.

### BACKGROUND OF THE INVENTION

1. Field of the Invention

The present invention relates to an optical disk drive with dust-proof function, and more particularly, to an optical disk drive with a dust-proof structure disposed on a bezel.

2. Description of the Prior Art

Recently, since the computer peripherals are progressing continuously and the price thereof is falling, the price of an optical disk drive is well-accepted by population. For example, a slim optical disk drive is a peripheral storage device of a notebook computer. With enhancing acceptance of the notebook computer, demands for the notebook computer are growing more and more in global market, so it brings the growing demands for the slim optical disk drive. However, since the environmental test specification of an electronic device is getting stricter, a dust-proof function of the electronic device for service life and stability in use is emphasized. The optical disk drive is a key component equipped with precise elements. If there is no dust-proof structure provided thereon, it is easy to cause damages on optical lenses in the sandy environment so as to reduce the service life of the optical disk drive and stability of operation thereof.

### SUMMARY OF THE INVENTION

The present invention provides an optical disk drive with a dust-proof structure disposed on a bezel for solving above drawbacks.

According to the claimed invention, an optical disk drive includes a main body including a tray and a casing for covering the tray. The optical disk drive further includes a bezel connected to aside of the casing of the main body. The bezel is used for shielding an opening of a housing when the main body is received inside the opening of the housing. The present invention further includes a dust-proof structure combined with the bezel for covering a gap between the bezel and the casing of the main body so as to provide a dust-proof function.

According to the claimed invention, the dust-proof structure is a frame structure disposed surrounding to a lateral side of the bezel.

According to the claimed invention, at least one positioning post is formed on the bezel for engaging inside a hole of the bezel.

According to the claimed invention, at least one wall is formed on the bezel for stopping the frame structure.

According to the claimed invention, the dust-proof structure is made of cushioning material.

According to the claimed invention, the dust-proof structure is made of sponge material, mylar material, conductive material, or rubber material.

According to the claimed invention, the dust-proof structure comprises a sheet-like structure for covering a side of the bezel, and a frame structure for disposing surrounding to an outer side of the sheet-like structure.

According to the claimed invention, at least one positioning post is formed on the bezel for engaging inside a hole of the bezel.

According to the claimed invention, at least one hot melting stick is formed on the bezel for combining with the sheet-like structure in a hot melting manner.

According to the claimed invention, the frame structure is glued to the sheet-like structure.

According to the claimed invention, the sheet-like structure is made of insulated material.

According to the claimed invention, the sheet-like structure is made of metal material.

According to the claimed invention, the sheet-like structure is made of conducting material.

According to the claimed invention, an electronic device includes a housing. An opening is formed on the housing. The electronic device further includes an optical disk drive installed inside the housing by passing through the opening of the housing. The optical disk device includes a main body including a tray and a casing for covering the tray. The optical disk drive further includes a bezel connected to a side of the casing of the main body. The bezel is used for shielding an opening of a housing when the main body is received inside the opening of the housing. The present invention further includes a dust-proof structure combined with the bezel for covering a gap between the bezel and the casing of the main body so as to provide a dust-proof function.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic device according to a preferred embodiment of the present invention.

FIG. 2 is a diagram of an optical disk drive according to the preferred embodiment of the present invention.

FIG. 3 is a schematic diagram of a bezel combined with a main body according to the preferred embodiment of the present invention.

FIG. 4 and FIG. 5 are respectively an exploded diagram and a diagram of the bezel combined with a dust-proof structure according to the preferred embodiment of the present invention.

FIG. 6 and FIG. 7 are respectively an exploded diagram and a diagram of a bezel combined with a dust-proof structure according to another preferred embodiment of the present invention.

FIG. 8 and FIG. 9 are respectively an exploded diagram and a diagram of a bezel combined with a dust-proof structure according to another preferred embodiment of the present invention.

### DETAILED DESCRIPTION

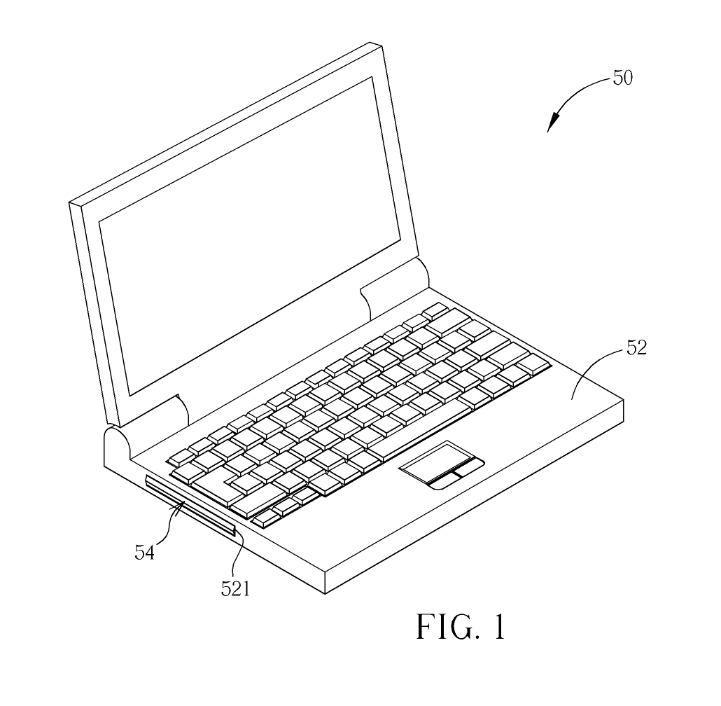

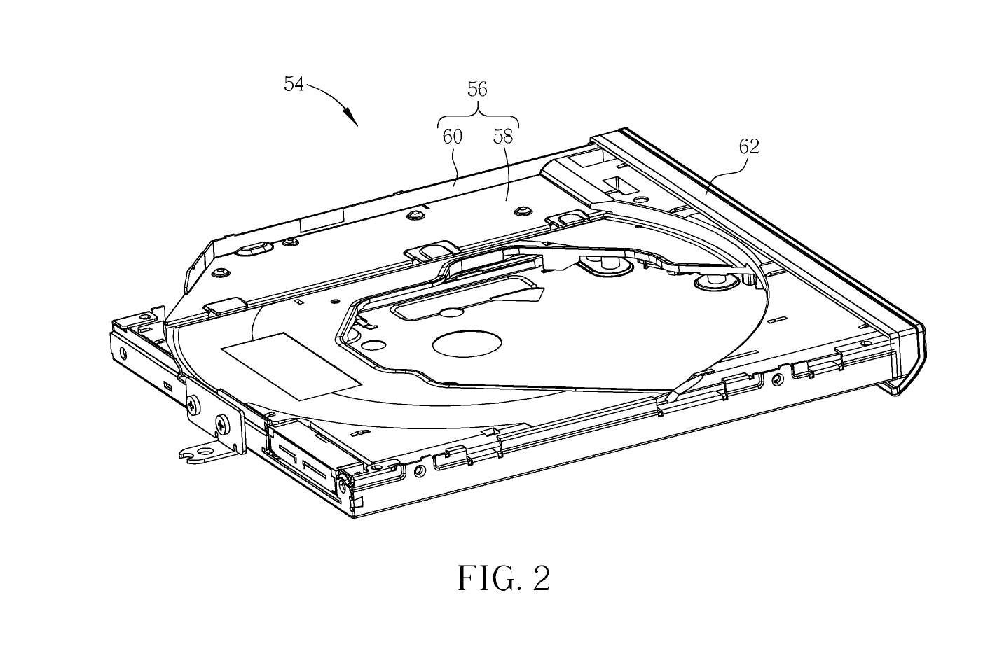

Please refer to FIG. 1. FIG. 1 is a diagram of an electronic device 50 according to a preferred embodiment of the present invention. The electronic device 50 can be a notebook computer and so on. The electronic device 50 includes a housing 52 for covering internal electronic components, and an opening 521 is formed on the housing 52. The electronic device 50 further includes an optical disk drive 54 for reading data stored in optical storage media, wherein the optical disk drive 54 can be a slim optical disk drive. Please refer to FIG. 2. FIG. 2 is a diagram of the optical disk drive 54 according to the preferred embodiment of the present invention. The optical disk drive 54 includes a main body 56 including a tray 58 for holding a mecha module. The main body 56 further includes a casing 60 for covering the tray 58 so as to protect the tray 58. The optical disk drive 54 further includes a bezel 62 connected to aside of the casing 60 of the main body 56. The bezel 62 is used for shielding the opening 521 when the main body 56 is received inside the opening 521 of the housing 52 so as to avoid foreign objects from falling into the housing 52 via the opening 521, and for keeping aesthetic feeling of appearance of the housing 52.

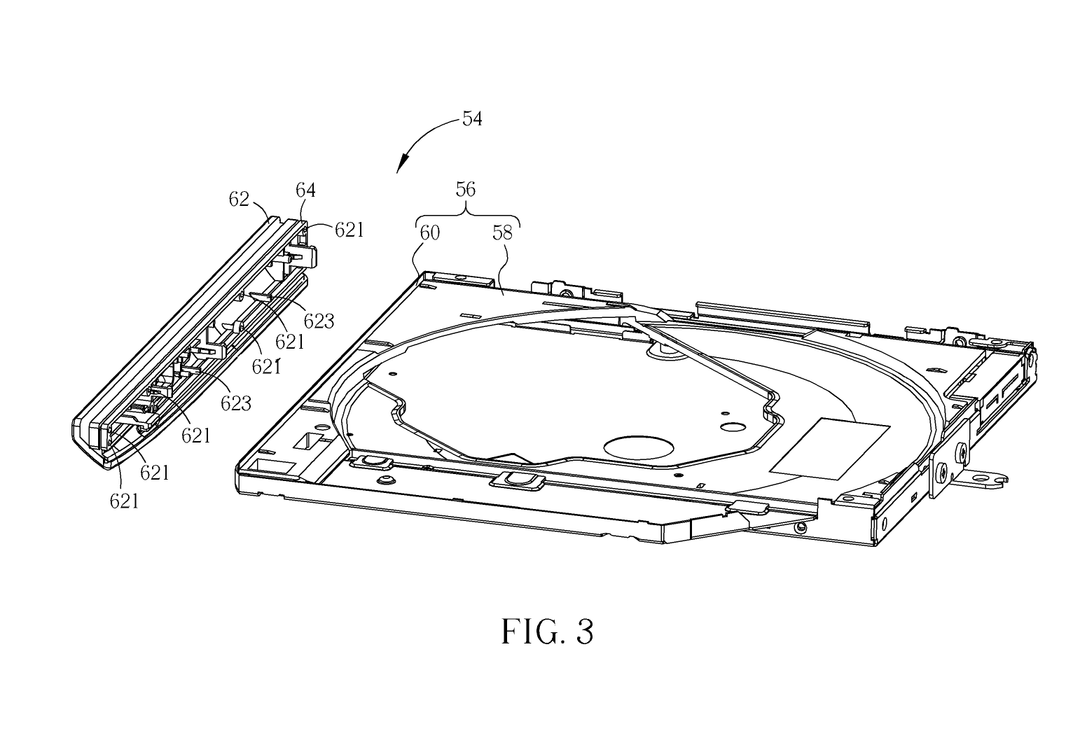

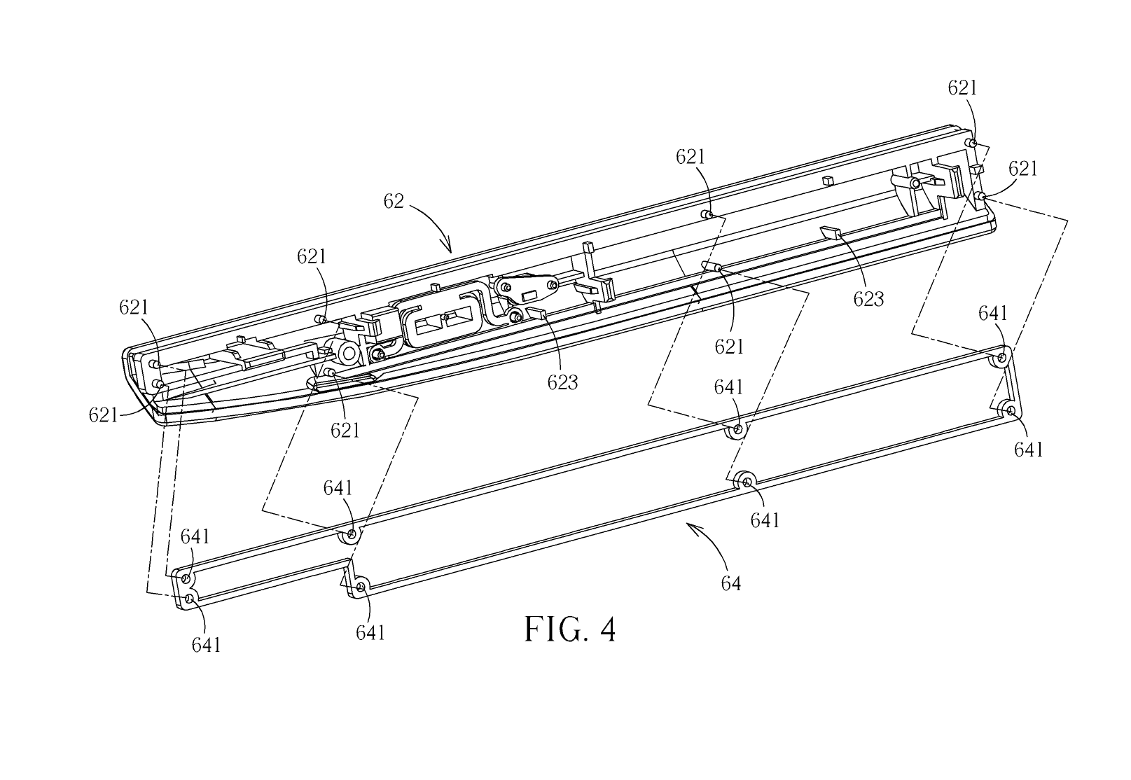

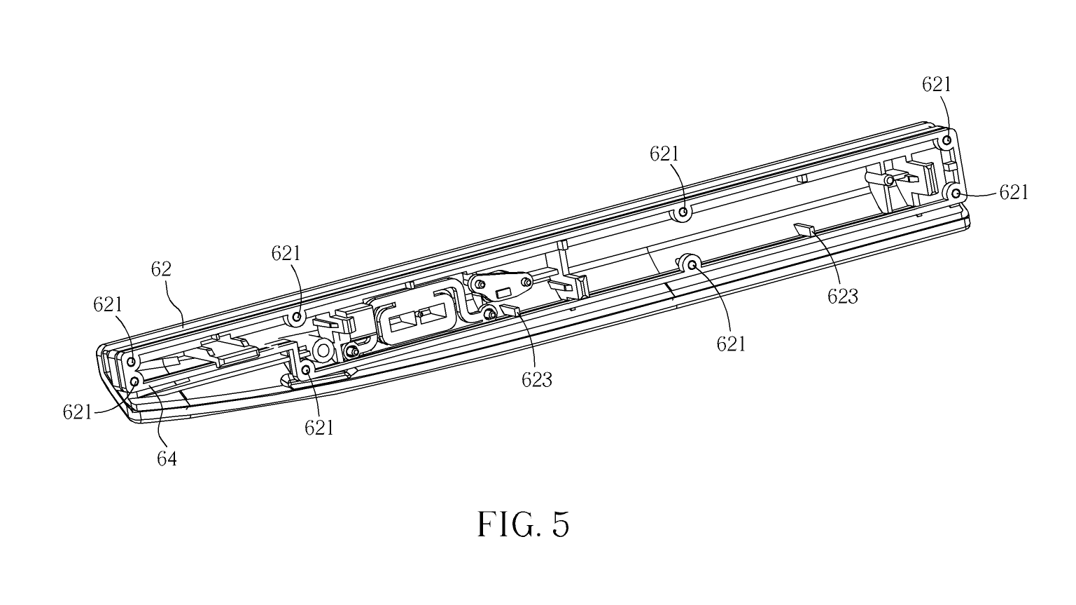

Please refer to FIG. 3 to FIG. 5. FIG. 3 is a schematic diagram of the bezel 62 combined with the main body 56 according to the preferred embodiment of the present invention. FIG. 4 and FIG. 5 are respectively an exploded diagram and a diagram of the bezel 62 combined with a dust-proof structure 64 according to the preferred embodiment of the present invention. The optical disk drive 54 further includes the dust-proof structure 64 combined with the bezel 62 for covering a gap between the bezel 62 and the casing 60 of the main body 56 so as to avoid the optical lenses from being damage due to dust falling into the main body 56 via the gap between the bezel 62 and the casing 60 of the main body 56. Accordingly, the dust-proof structure 64 can provide a dust-proof function. The dust-proof structure 64 can be made of cushioning material, such as sponge material, mylar material, conductive material (e.g. conductive fabric or conductive sponge and so on), or rubber material. In such a manner, when the bezel 62 is installed on a side of the main body 56, the dust-proof structure 64 located therebetween can be slightly compressed. Accordingly, it can firmly cover the gap between the bezel 62 and the casing 60 of the main body 56 so as to enhance the dust-proof function. In addition, if the dust-proof structure 64 is made of conductive material (e.g. conductive fabric or conductive sponge and so on), it can contact with the casing 60 made of metal material so as to provide a grounding function. In such a manner, the machine can avoid from being damaged due to a high-voltage shock. In this embodiment, the dust-proof structure 64 is a frame structure disposed surrounding on a lateral side of the bezel 62, that is, the dust-proof structure 64 surrounds the internal components covered by the bezel 62 so as to avoid the dust from stacking inside the bezel 62. In order to fix the dust-proof structure 64 on the bezel 62 stably, at least one positioning post 621 is formed on the bezel 62 for engaging the dust-proof structure 64. In other words, at least one hole 641 is formed on the bezel 62, and the positioning post 621 is inserted into the hole 641 correspondingly, so as to fix the dust-proof structure 64. In addition, at least one wall 623 is formed on the bezel 62 for stopping the dust-proof structure 64, so as to constrain the dust-proof structure 64 and to avoid the dust-proof structure 64 from loosing. It should be noticed that the wall 623 can be a necessary component of the bezel 62 combined with other structural components, or can be an additional structure disposed for fixing the dust-proof structure 64, and it depends on design demand.

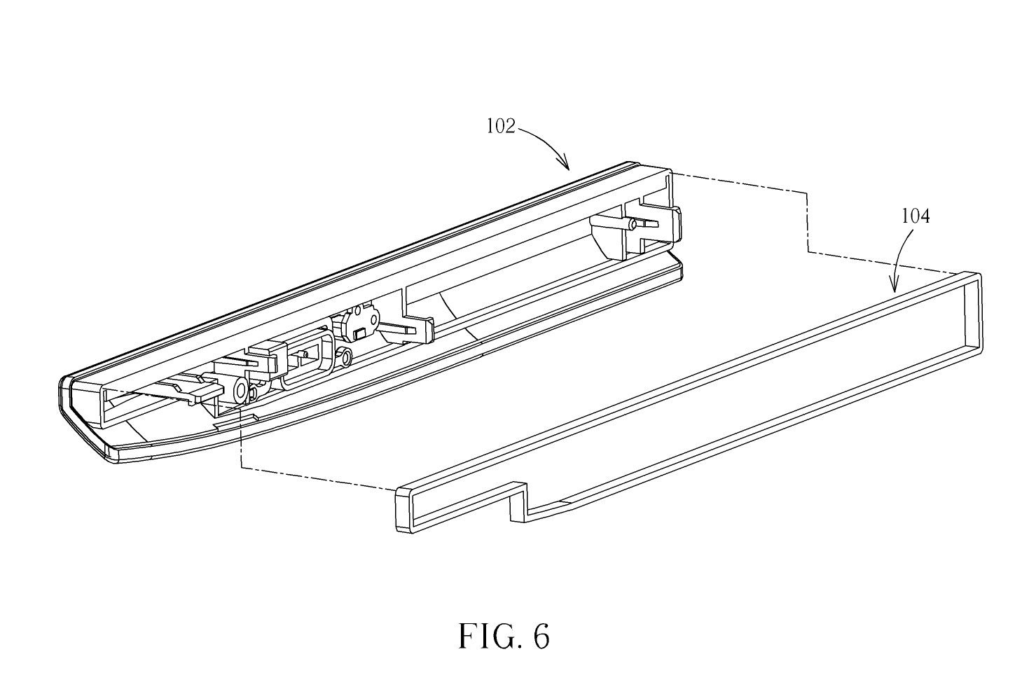

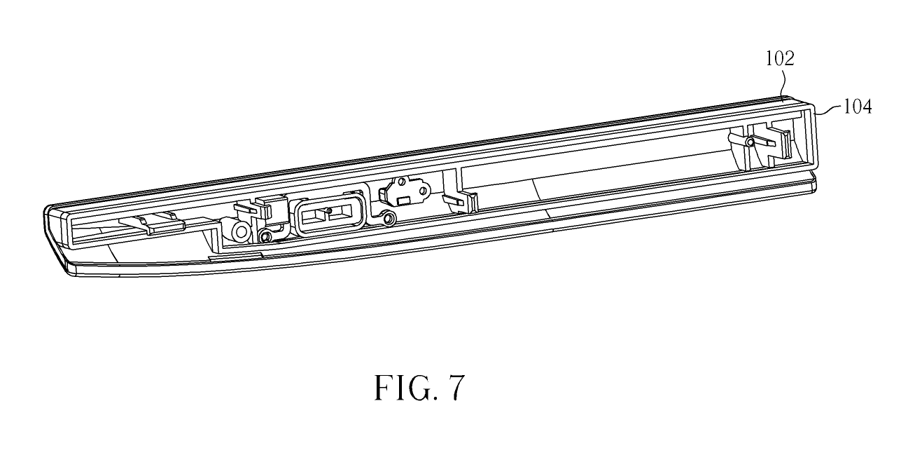

Please refer to FIG. 6 and FIG. 7. FIG. 6 and FIG. 7 are respectively an exploded diagram and a diagram of a bezel 102 combined with a dust-proof structure 104 according to another preferred embodiment of the present invention. In this embodiment, the dust-proof structure 104 is glued to a structural component of the bezel 102 and sheathes on an outer side of the bezel 102. In other words, disposal of the positioning post and the wall in the above-mentioned embodiment can be selective. Structures allowing the bezel be combined with the dust-proof structure are within the scope of the present invention.

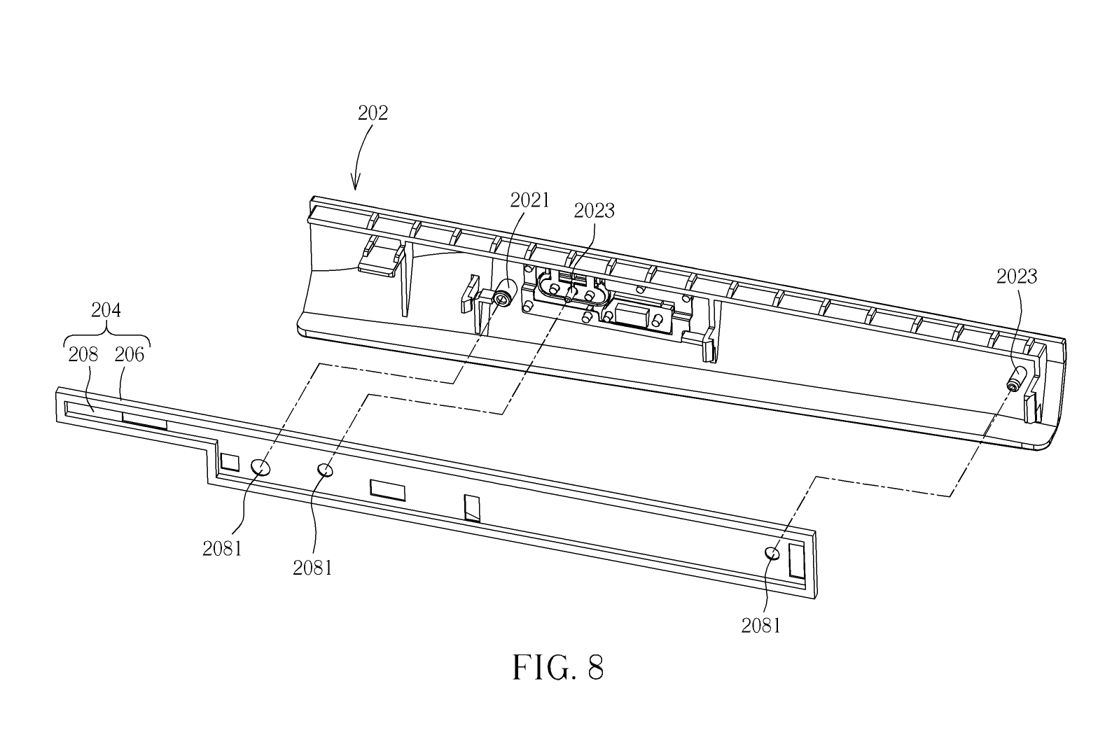

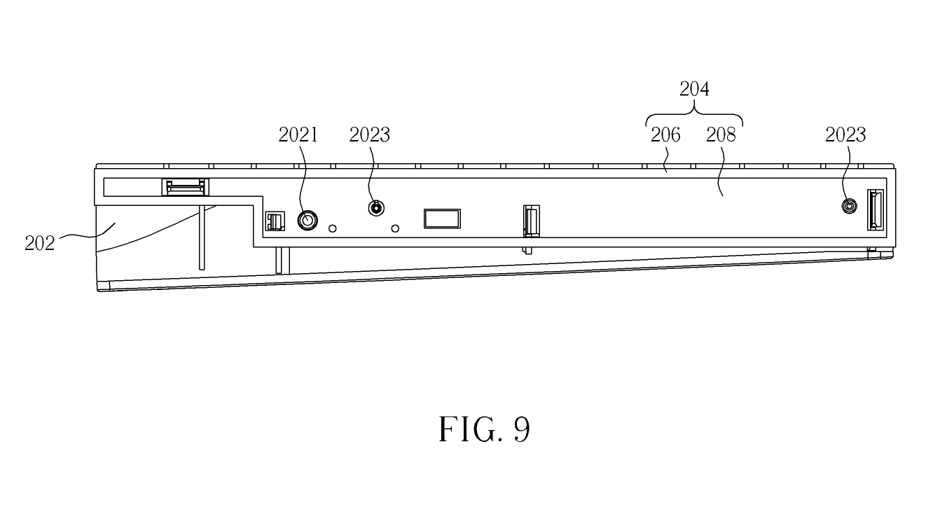

Except for the frame structure as the dust-proof structure in the above-mentioned embodiment, the dust-proof structure can adopt other types of structures as well. Please refer to FIG. 8 and FIG. 9. FIG. 8 and FIG. 9 are respectively an exploded diagram and a diagram of a bezel 202 combined with a dust-proof structure 204 according to another preferred embodiment of the present invention. The dust-proof structure 204 includes a frame structure 206 and a sheet-like structure 208. The frame structure 206 is disposed surrounding to an outer side of the sheet-like structure 208, and the sheet-like structure 208 is for covering a side of the bezel 202. At least one positioning post 2021 is formed on the bezel 202 for engaging inside at least one corresponding hole 2081 on the sheet-like structure 208, and at least one hot melting stick 2023 is formed on the bezel 202 for combining with the corresponding hole 2081 on the sheet-like structure 208 in a hot melting manner. Therefore, both the positioning post 2021 and the hot melting stick 2023 are mechanisms for fixing the dust-proof structure 204 to the bezel 202 wherein disposal of the positioning post 2021 and the hot melting stick 2023 can be selective. In other words, either the positioning post 2021 or the hot melting stick 2023 can be disposed, or alternatively, the positioning post 2021 and the hot melting stick 2023 can be disposed simultaneously.

For example, the sheet-like structure 208 can be made of insulated material, plastic material, metal material, rubber material, silicon material, or conductive material. If the sheet-like structure 208 is made of insulated material or plastic material, the sheet-like structure 208 can be fixed to the bezel 202 by glue, the positioning 2021, the hook ,or the hot melting stick 2023 in a hot melting manner. If the sheet-like structure 208 is made of metal material, the sheet-like structure 208 can be fixed to the bezel 202 by the hot melting stick 2023 in a hot melting manner, the hook, glue, or positioning post 2021. If the sheet-like structure 208 is made of conductive material, it can contact with the casing made of metal material so as to provide a grounding function. In such a manner, the machine can avoid from being damaged due to high-voltage shock. Or if the sheet-like structure 208 is made of conductive material, it can contact with the casing made of plastic material, and the sheet-like structure 208 can be glued to or fixed to the bezel 202 by the positioning post 2021. In addition, if the sheet-like structure 208 is made of rubber material or silicon material, the sheet-like structure 208 can be fixed to the bezel 202 by glue, the positioning post 2021, the hot melting stick 2023 in a hot melting manner, or the hook.

Furthermore, the frame structure 206 can be made of sponge material, mylar material, conductive material (e.g. conductive fabric or conductive sponge and so on), or rubber material. In such a manner, when the bezel 62 is installed on a side of the main body 56, the dust-proof structure 64 located therebetween can be slightly compressed. Accordingly, it can firmly cover the gap between the bezel 62 and the casing 60 of the main body 56 so as to enhance the dust-proof function. In addition, if the dust-proof structure 64 is made of conductive material (e.g. conductive fabric or conductive sponge and so on), it can contact with the casing 60 made of metal material so as to provide a grounding function. In such a manner, the machine can avoid from being damaged due to high-voltage shock. In addition, the frame structure 206 is preferably glued to the sheet-like structure 208, and the sheet-like structure 208 can strengthen rigidity of the dust-proof structure 204 so as to enhance convenience of assembly of the dust-proof structure 204. Furthermore, the sheet-like structure 208 can avoid the dust from falling into the main body 56 via the opening of the bezel 62, such as via the opening for indicating light, operating button and so on, so as to enhance effect of dust-proof.

Compared with the prior art, the present invention provides the dust-proof structure on the bezel of the optical disk drive. Since the dust-proof structure covers the gap between the bezel and the casing of the main body so as to avoid the optical lenses from being damaged due to the dust falling into the main body via the opening of the bezel and via the gap between the bezel and the casing of the main body, especially for the sandy environment, the present invention enhance the service life of the optical disk drive and stability of operation thereof.

Those skilled in the art will readily observe that numerous modifications and alterations of the device and method may be made while retaining the teachings of the invention.

What is claimed is:

1. An optical disk drive, comprising:
a main body comprising a tray and a casing for covering the tray;
a bezel connected to a side of the casing of the main body, the bezel being used for shielding an opening when the main body is received inside the opening of a housing; and
a dust-proof structure combined with the bezel for covering a gap between the bezel and the casing of the main body so as to provide a dust-proof function.

2. The optical disk drive of claim 1, wherein the dust-proof structure is a frame structure disposed surrounding to a lateral side of the bezel.

3. The optical disk drive of claim 2, wherein at least one positioning post is formed on the bezel for engaging inside a hole of the bezel.

4. The optical disk drive of claim 2, wherein at least one wall is formed on the bezel for stopping the frame structure.

5. The optical disk drive of claim 1, wherein the dust-proof structure is made of cushioning material.

6. The cushioning material of claim 5, wherein the dust-proof structure is made of sponge material, mylar material, conductive material, or rubber material.

7. The optical disk drive of claim 1, wherein the dust-proof structure comprises a sheet-like structure for covering a side of the bezel, and a frame structure for disposing surrounding to an outer side of the sheet-like structure.

8. The optical disk drive of claim 7, wherein at least one positioning post is formed on the bezel for engaging inside a hole of the bezel.

9. The optical disk drive of claim 7, wherein at least one hot melting stick is formed on the bezel for combining with the sheet-like structure in a hot melting manner.

10. The optical disk drive of claim 7, wherein the frame structure is glued to the sheet-like structure.

11. The optical disk drive of claim 7, wherein the sheet-like structure is made of insulated material.

12. The optical disk drive of claim 7, wherein the sheet-like structure is made of metal material.

13. The optical disk drive of claim 7, wherein the sheet-like structure is made of conducting material.

14. An electronic device, comprising:
a housing, an opening being formed on the housing; and
an optical disk drive installed inside the housing by passing through the opening of the housing, the optical disk device comprising:
a main body comprising a tray and a casing for covering the tray;
a bezel connected to a side of the casing of the main body, the bezel being used for shielding the opening when the main body is received inside the opening of the housing; and
a dust-proof structure combined with the bezel for covering a gap between the bezel and the casing of the main body so as to provide a dust-proof function.

15. The electronic device of claim 14, wherein the dust-proof structure is a frame structure disposed surrounding to a lateral side of the bezel.

16. The electronic device of claim 14, wherein at least one positioning post is formed on the bezel for engaging inside a hole of the bezel.

17. The electronic device of claim 14, wherein the dust-proof structure is made of cushioning material.

18. The electronic device of claim 14, wherein the dust-proof structure comprises a sheet-like structure for covering a side of the bezel, and a frame structure for disposing surrounding to an outer side of the sheet-like structure.

19. The electronic device of claim 18, wherein at least one hot melting stick is formed on the bezel for combining with the sheet-like structure in a hot melting manner.

20. The electronic device of claim 18, wherein the frame structure is glued to the sheet-like structure.
